(19) United States
(12) Patent Application Publication
(10) Pub. No.: US 2025/0256927 A1
(43) Pub. Date: Aug. 14, 2025

(54) DEVICES AND SYSTEMS FOR PNEUMATIC TUBE TRANSPORT

(71) Applicant: VANDERBILT UNIVERSITY, Nashville, TN (US)

(72) Inventors: Joseph Richard Wiencek, Nashville, TN (US); Kiara Herro, Nashville, TN (US); Maxwell Sharp, Nashville, TN (US); Layla Reejhsinghani, Nashville, TN (US); Marin Schiffman, Nashville, TN (US); Marc Moore, Nashville, TN (US)

(21) Appl. No.: 19/049,251

(22) Filed: Feb. 10, 2025

Related U.S. Application Data
(60) Provisional application No. 63/551,753, filed on Feb. 9, 2024.

(51) Int. Cl. B65G 51/36

(52) U.S. Cl. CPC B65G 51/36; B65G 2203/0291; B65G 2203/042

(57) ABSTRACT

A sample transportation system, in particular embodiments, comprises: a housing; at least one gyroscope sensor disposed within the housing; a substantially linear track disposed within the housing; a sample receptacle slidably coupled to the substantially linear track; and at least one motor in mechanical communication with at least one of the sample receptacle or the substantially linear track. In various embodiments, the at least one motor is configured to cause the sample receptacle to translate parallel to the substantially linear track with respect to the housing. In some embodiments, the system further comprises computing hardware configured to receive velocity data from the at least one gyroscope sensor, and operate the at least one motor to cause the sample receptacle to translate with respect to the housing based on the velocity data.

### CROSS-REFERENCE TO RELATED APPLICATION

This application claims the benefit of U.S. Provisional Patent Application Ser. No., 63/551,753, filed Feb. 9, 2024, the disclosure of which is hereby incorporated herein by reference in its entirety.

### BACKGROUND

Blood samples and other items are often transported in pneumatic tube systems, for example, in a hospital setting. Transportation of certain types of samples in a pneumatic tube system, may, for example, have a negative impact on the samples and reduce their viability for the samples' intended use once they reach their destination. Accordingly, there is a need for improved systems and methods for transporting samples and other items while reducing potential negative impact on the samples.

### SUMMARY

In accordance with the purpose(s) of the present disclosure, as embodied and broadly described herein, the disclosure, in one aspect, relates to systems and devices for transporting materials by pneumatic tube transport. The systems can include a device used with a pneumatic tube for transporting materials such as biological specimens (e.g., blood). The device can reduce damage done to materials during transport in a pneumatic tube system.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure. In addition, all optional and preferred features and modifications of the described embodiments are usable in all aspects of the disclosure taught herein.

In particular embodiments, a sample transportation system comprises: a housing; at least one gyroscope sensor disposed within the housing; a substantially linear track disposed within the housing; a sample receptacle slidably coupled to the substantially linear track; at least one motor in mechanical communication with at least one of the sample receptacle or the substantially linear track, the at least one motor configured to cause the sample receptacle to translate parallel to the substantially linear track with respect to the housing; and computing hardware disposed within the housing and coupled to the at least one gyroscope sensor. In some embodiments, the substantially linear track is substantially parallel to a longitudinal direction of travel of the housing within the sample transportation system.

In various embodiments, the computing hardware is configured to: receive velocity data from the at least one gyroscope sensor; and operate the at least one motor to cause the sample receptacle to translate with respect to the housing based on the velocity data.

In some embodiments, operating the at least one motor to cause the sample receptacle to translate with respect to the housing based on the velocity data comprises operating the at least one motor to translate the sample receptacle antiparallel to a direction of travel identified based on the velocity data. In other embodiments, the sample transportation system further comprises: a second substantially linear track disposed within the housing; and a second motor in mechanical communication with at least one of the sample receptacle or the second substantially linear track. In various embodiments, the second substantially linear track is oriented in a first transverse direction that is substantially perpendicular to the longitudinal direction of travel of the housing within the sample transportation system. In some embodiments, the second motor is configured to cause the sample receptacle to translate parallel to the first transverse direction. In various embodiments, a first end of the substantially linear track is slidably coupled to the second substantially linear track. In particular embodiments, the computing hardware is further configured to operate the second motor to cause the sample receptacle to translate in the transverse direction with respect to the housing based on the velocity data.

In various embodiments, the sample transportation system further comprises a third substantially linear track disposed within the housing, the third substantially linear track being oriented in a second transverse direction that is substantially perpendicular to both the longitudinal direction and the second longitudinal direction. The sample transportation system may further comprise a third motor in mechanical communication with at least one of the sample receptacle or the third substantially linear track. In some embodiments, the third motor is configured to cause the sample receptacle to translate parallel to the second transverse direction, and the computing hardware is further configured to operate the third motor to cause the sample receptacle to translate in the second transverse direction with respect to the housing based on the velocity data.

In some embodiments, the sample transportation system is configured for at least one of insertion into a pneumatic tube carrier for use in the sample transportation system or standalone use in the sample transportation system. In particular embodiments, the substantially linear track comprises at least one integrated dampener. In various embodiments, operating the at least one motor to cause the sample receptacle to translate with respect to the housing based on the velocity data comprises causing the sample receptacle to translate in the longitudinal direction at a velocity opposite a velocity determined from the velocity data.

A pneumatic tube carrier, in various embodiments, comprise: a longitudinal direction support that is substantially parallel to a longitudinal direction of travel of the pneumatic tube carrier when the pneumatic tube carrier is travelling through a pneumatic tube system; a sample housing disposed on the longitudinal direction support; at least one actuator operatively coupled to the sample housing and configured to cause the sample housing to translate substantially parallel along at least a portion of the longitudinal direction support; at least one sensor disposed on or in the pneumatic tube carrier; and computing hardware operatively coupled to the at least one sensor and the at least one actuator, wherein the computing hardware is configured for: receiving sensor data from the at least one sensor; determining a set of actuator instructions based on the sensor data; and operating the at least one actuator according to the set of actuator instructions to at least partially counteract a force, velocity, direction of motion, or acceleration identified based on the sensor data.

In some embodiments, the longitudinal direction support comprises at least one integrated dampener. In some aspects, the at least one integrated dampener comprise at least one biasing mechanism or at least one dashpot. In some aspects, the sensor data comprises a force on the pneumatic tube carrier. In various aspects, the responsive action comprises causing the at least one actuator to apply a force that is opposing of the force on the pneumatic tube carrier on the sample housing.

In particular embodiments, the at least one actuator comprises a set of actuators; and the set of actuators are configured to cooperate to at least partially counteract the force, velocity, direction of motion, or acceleration identified by translating the sample housing in three dimensions. In some embodiments, the pneumatic tube carrier further comprises a first transverse direction support substantially perpendicular to the longitudinal direction support. In some embodiments, the at least one actuator is further configured to cause the sample housing to translate substantially parallel along at least a portion of the first transverse direction support. In particular embodiments, the pneumatic tube carrier further comprises a second transverse direction support substantially perpendicular to the longitudinal direction support and the first transverse direction support, wherein the at least one actuator is further configured to cause the sample housing to translate substantially parallel along at least a portion of the second transverse direction support.

A pneumatic tube insert, in particular embodiments, comprises: a sample housing; at least one actuator operatively coupled to the sample housing and configured to cause the sample housing to translate in a direction substantially parallel to a longitudinal direction of travel of the pneumatic tube insert when the pneumatic tube insert is travelling through a pneumatic tube system; at least one sensor disposed on or in the pneumatic tube insert; and computing hardware operatively coupled to the at least one sensor and the at least one actuator. In some embodiments, the computing hardware is configured for: receiving sensor data from the at least one sensor; determining a responsive action based on the sensor data; and causing the responsive action.

In some embodiments, the sensor data comprises a velocity of the pneumatic tube insert; the responsive action comprises causing the sample housing to translate in the longitudinal direction in a direction opposite the velocity of the pneumatic tube insert at a rate that corresponds to the velocity; and causing the responsive action comprises causing the at least one actuator to translate the sample housing in the longitudinal direction in the direction opposite the velocity of the pneumatic tube insert at the rate that corresponds to the velocity. In various embodiments, the pneumatic tube insert is configured to be selectively inserted into a pneumatic tube carrier for use in the pneumatic tube system.

In particular embodiment, the at least one sensor comprises at least one of a gyroscope, an accelerometer, or a temperature sensor; and the responsive action comprises at least one of activating the at least one actuator, generating a temperature alert; or generating an excessive force alert.

In some embodiments, the pneumatic tube insert comprises: a first transverse direction rack; an actuator support defining a linear track, wherein the actuator support is configured to receive the at least one actuator and the linear track is configured to receive at least a portion of the first transverse direction rack such that the first transverse direction rack is slidably disposed within the linear track; and a rotating connector coupled to the at least one actuator, the rotating connector in operable engagement with the first transverse direction rack. In some embodiments, a first end of the sample housing is coupled to the first transverse direction rack. In various embodiments, the responsive action comprises operating the at least one actuator to rotate the rotating connector to cause the first transverse direction rack to translate at least the first end of the sample housing in a transverse direction relative to the longitudinal direction of travel of the pneumatic tube insert when the pneumatic tube insert is travelling through the pneumatic tube system.

In various embodiments, the actuator support comprises a second transverse direction rack substantially perpendicular to the transverse direction rack, and the pneumatic tube insert comprises a second actuator support defining a second linear track. In some embodiments, the second actuator support is configured to receive a second actuator, and the second linear track is configured to receive at least a portion of the second transverse direction rack such that the second transverse direction rack is slidably disposed within the second linear track. In some embodiments, a second rotating connector is coupled to the second actuator, the second rotating connector in operable engagement with the second transverse direction rack; the responsive action comprises operating the second actuator to rotate the second rotating connector to cause the second transverse direction rack to translate at least the actuator support in the second transverse direction relative to the longitudinal direction of travel of the pneumatic tube insert when the pneumatic tube insert is travelling through the pneumatic tube system; and the transverse direction is substantially perpendicular to the second transverse direction.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

Drawings are presented in the attachment files accompanying this specification:

FIG. 1 is a cutaway view of a pneumatic tube transport device in accordance with various embodiments of the present disclosure.

FIG. 2 is a cutaway view of a pneumatic tube transport device in accordance with various other embodiments of the present disclosure.

FIG. 3 is a cutaway view of a pneumatic tube transport device in accordance with various other embodiments of the present disclosure.

FIG. 4 is a pneumatic tube transport device in accordance with still other embodiments of the present disclosure.

FIG. 5 is a perspective view of the pneumatic tube transport device shown in FIG. 4.

FIG. 6 is an exploded view of the pneumatic tube transport device shown in FIG. 4.

FIG. 7 is a detail view of an actuator support of the pneumatic tube transport device shown in FIG. 4 in accordance with various embodiments of the present disclosure.

FIGS. 8-10 are detail views of yet another actuator support of the pneumatic tube transport device shown in FIG. 4 in accordance with various embodiments of the present disclosure.

FIG. 11 is a detail view of an actuator support and transverse direction rack of the pneumatic tube transport device shown in FIG. 4 in accordance with various embodiments of the present disclosure.

FIG. 12 is a detail view of a sample housing of the pneumatic tube transport device shown in FIG. 4 in accordance with various embodiments of the present disclosure.

FIG. 13 is an exploded view of the sample housing shown in FIG. 12 in accordance with various embodiments of the present disclosure.

FIG. 14 is a detail view of a set of transverse direction sliders of the pneumatic tube transport device shown in FIG. 4 in accordance with various embodiments of the present disclosure.

FIG. 15 is a detail view of a first transverse direction slider in accordance with various embodiments of the present disclosure.

FIG. 16 is a detail view of a second transverse direction slider and first transverse direction slider support track in accordance with various embodiments of the present disclosure.

FIG. 17 is a rear view of the second transverse direction slider shown in FIG. 16.

FIG. 18 is a process for controlling pneumatic tube transport device components based on sensor data in accordance with various embodiments of the present disclosure.

Additional advantages of the invention will be set forth in part in the description which follows, and in part will be obvious from the description, or can be learned by practice of the invention. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the disclosure. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method and/or process can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a spacer,” “a guide nucleic acid,” or “an miRNA,” including, but not limited to, mixtures or combinations of two or more such spacers, guide nucleic acids, or miRNAs, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Overview

As noted above, pneumatic tube systems are often utilized to transport blood samples and other materials, particularly in a hospital setting. Such systems may, for example, transport samples from a point of origin to a testing location. When traveling via pneumatic tube system, samples may experience less-than-ideal environmental conditions as a result of forces exerted on the samples during transportation. For example, samples such as blood samples can experience high shock, g-forces, and rapid acceleration changes during transport.

As a result of such environmental conditions, particular samples may become unsuitable or unviable for a type of testing or other analysis that was to be performed on the samples. For example, in the case of blood samples, hemolysis of red blood cells may occur as a result of forces exerted on the samples during pneumatic tube transportation. Such samples may become unusable or produce unreliable or erroneous test results.

As a result, caregivers may need to retrieve additional samples from patients, resort to less efficient transportation techniques such as physically carrying the samples to the proper testing facility, etc. In some cases, inefficiencies resulting from a desire to avoid potential sample spoliation from utilizing pneumatic tube systems can affect patient outcomes, waste resources, etc. Various embodiments of a pneumatic tube transportation device described herein may reduce at least some negative impacts resulting from environmental conditions during pneumatic tube transportation.

### Pneumatic Tube Carriers and Inserts

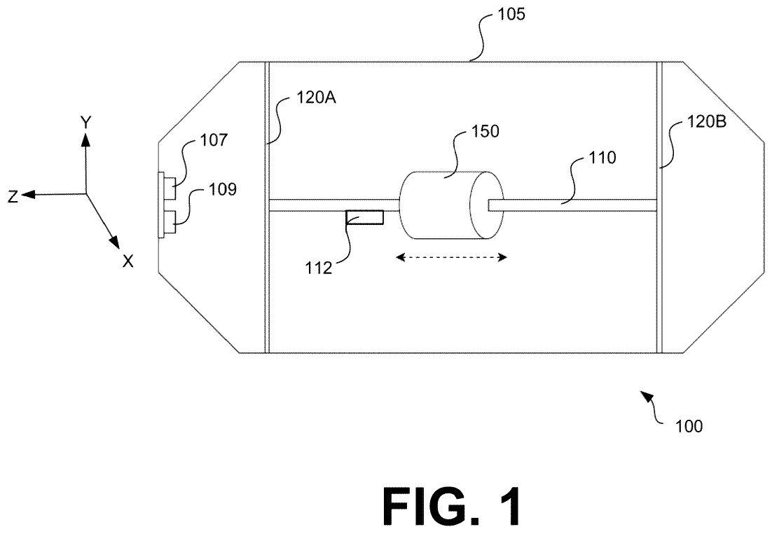

FIG. 1 depicts a pneumatic tube transport device 100 in accordance with various embodiments of the present disclosure. As may be understood from this figure, the pneumatic tube transport device 100 comprises a housing 105. In various embodiments, the housing 105 is substantially cylindrical. In some embodiments, the housing 105 may comprise an insert for an existing pneumatic tube carrier. In such embodiments, the pneumatic tube transport device 100 may be configured for insertion into an existing pneumatic tube carrier. In still other embodiments, the pneumatic tube transport device 100 may comprise a housing 105 that is sized and structured to function as a stand-alone pneumatic tube carrier (e.g., for use directly within a pneumatic tube system). In this way, in various embodiments, the pneumatic tube transport device 100 may be configured for stand-alone use in a pneumatic tube system. In still other embodiments, the pneumatic tube transport device 100 may be configured for use in a pneumatic tube system as an insert to an existing pneumatic tube carrier.

As may be further understood from FIG. 1, the pneumatic tube transport device 100 is sized and shaped to travel through a pneumatic tube system, for example, through insertion into an existing pneumatic tube carrier or directly as a stand-alone pneumatic tube transport device 100. In particular embodiments, the pneumatic tube transport device 100 comprises at least one longitudinal direction support 110. In various embodiments, the longitudinal direction support 110 is substantially linear and oriented substantially parallel to a longitudinal direction of travel of the pneumatic tube transport device 100 when the pneumatic tube transport device 100 is traveling through a pneumatic transportation system. In particular embodiments, the pneumatic tube transport device 100 further comprises a sample housing 150 configured to receive and at least temporarily store one or more samples. In some aspects, the one or more samples may include one or more test tubes, vials, or other storage mediums. In particular embodiments, the sample housing 150 is disposed at least partially on and/or around the longitudinal direction support 110 or otherwise coupled to the longitudinal direction support 110. In various embodiments, the sample housing 150 is slidably coupled to the longitudinal direction support 110 such that the sample housing 150 is at least partially movable along a length of the longitudinal direction support 110 within the pneumatic tube transport device 100. In this way, the pneumatic tube transport device 100 is configured such that a position of the sample housing 150 within the pneumatic tube transport device 100 (e.g., along the longitudinal direction support 110) can be altered via operation of one or more motors, one or more linear actuators, one or more dampening mechanisms, one or more biasing mechanisms, or through operation of any other suitable component of the pneumatic tube transport device 100.

In various aspects, the longitudinal direction support 110 is supported by at least one first transverse direction support 120. For example, in the embodiment shown in FIG. 1, a first end of the longitudinal direction support 110 is coupled to the housing 105 via a first transverse direction support 120A and a second end of the longitudinal direction support 110 is coupled to the housing 105 via a first transverse direction support 120B. As shown in FIG. 1, each of the first transverse direction support 120A and the first transverse direction support 120B are substantially perpendicular to a longitudinal axis of the pneumatic tube transport device 100 (e.g., the Z-direction). Each of the first transverse direction support 120A and the first transverse direction support 120B may also be substantially perpendicular to the longitudinal direction support 110. In some aspects, each of the first transverse direction support 120A and the first transverse direction support 120B may comprise one or more telescoping rods or other adjustable components. In this way, the first transverse direction support 120A and/or first transverse direction support 120B may be configured to expand to fit substantially snugly within an existing pneumatic tube carrier.

In still other embodiments, the pneumatic tube transport device 100 may comprise any suitable support configuration for maintaining the pneumatic tube transport device 100 in an orientation that is at least substantially parallel to the longitudinal direction of travel of the pneumatic tube transport device 100. In various embodiments the pneumatic tube transport device 100 comprise at least one first actuator 112. In the embodiment shown in this figure, the first actuator 112 is disposed adjacent the longitudinal direction support 110. In still other embodiments, the first actuator 112 may be disposed in any other suitable location. In particular embodiments, the first actuator 112 is configured to cause the sample housing 150 to translate (e.g., and/or rotate) with respect to the longitudinal direction support 110. In various embodiments, the first actuator 112 may comprise any suitable actuator. For example, in particular embodiments, the first actuator 112 may include one or more suitable actuators that provide force, torque, and/or displacement to one or more other components of the pneumatic tube transport device 100. In some embodiment, the first actuator 112 includes any suitable actuator configured to translate electrical, pneumatic, hydraulic, or other input into mechanical energy. In some embodiments, the first actuator 112 comprises a linear actuator. In other embodiments, the first actuator 112 comprises a rotational actuator. In various embodiments, the first actuator 112 is configured to convert rotational motion to linear motion in combination with one or more other components. For example, in various embodiments, the first actuator 112 may operate in combination with a rack and pinion or other suitable mechanism for providing linear motion to one or more other aspects of the pneumatic tube transport device 100, such as the sample housing 150.

In a particular embodiment, the pneumatic tube transport device 100 comprises one or more sensors, such as a gyroscope 107 configured to detect an orientation of the pneumatic tube transport device 100, an angular velocity and/or change in angular velocity of the pneumatic tube transport device 100, etc. In still other embodiments, the one or more sensors may include any other suitable sensor such as one or more temperature sensors, one or more accelerometers, one or more pressure sensors, one or more inertial sensors, etc. In any embodiment described herein, the one or more sensors (i.e., the gyroscope 107 in particular embodiments) may be disposed in any suitable location on the pneumatic tube transport device 100. In various embodiments, the one or more sensors are disposed in any suitable location other than the sample housing 150.

In various embodiments, the pneumatic tube transport device 100 further comprises a control circuitry 109 configured to receive one or more sensor readings from the one or more sensors. In any embodiment described herein, the control circuitry 109 may comprise any suitable processing circuitry configured to receive and interpret sensor data from the gyroscope 107, determine opposing force and/or motion data to at least partially counteract a motion and/or force on the sample housing 150, and cause the first actuator 112 to at least temporarily impart an at least partially counteracting motion and/or force on the sample housing 150. In a particular embodiment the control circuitry 109 comprises an Arduino Nano.

The control circuitry 109 may then be configured to operate the first actuator 112 to cause the sample housing 150 to translate along the first actuator 112, adjust a position or orientation of the sample housing 150 with respect to the pneumatic tube transport device 100, apply a force to the sample housing 150, or otherwise modify a velocity and/or acceleration of the sample housing 150 with respect to the pneumatic tube transport device 100. In some embodiments, the control circuitry 109 is configured to operate the first actuator 112 to modify a position, velocity, and/or acceleration of the sample housing 150 with respect to the pneumatic tube transport device 100 based on one or more readings received from the one or more sensors (e.g., the gyroscope 107).

In some embodiments, for example, the control circuitry 109 is configured to cause the first actuator 112 to move the sample housing 150 in a direction opposite a motion detected via the gyroscope 107 (e.g., or other suitable sensor). In this way, the pneumatic tube transport device 100, in various embodiments, is configured to reduce an amount of force exerted on a sample disposed within the sample housing 150 during transportation. In some embodiments, the sample housing 150 may be further configured to rotate about the longitudinal direction support 110 (e.g., through operation of the first actuator 112 or other suitable motor or actuation device). In such embodiment, the first actuator 112 or other motor may be configured to apply a rotational force to the sample housing 150 with respect to the longitudinal direction support 110. In such embodiments, the control circuitry 109 may be further configured to cause such a first actuator 112 to apply the rotational force to the sample housing 150 to counteract a rotational force detected by the gyroscope 107 (e.g., or other sensor).

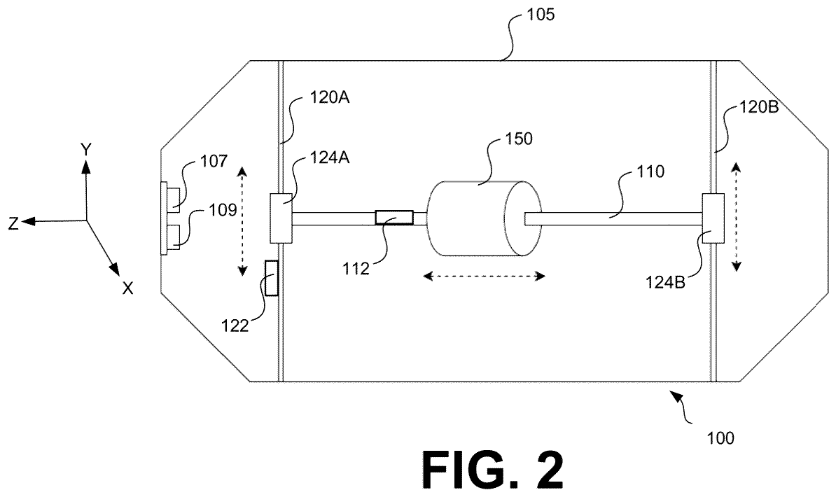

FIG. 2 depicts another embodiment of a pneumatic tube transport device 100. As shown in FIG. 2, in various embodiments, a pneumatic tube transport device 100, in addition to compensating for forces on the sample housing 150 in the longitudinal direction of motion of the pneumatic tube transport device 100 through a pneumatic tube system, may be configured to counteract one or more forces on the sample housing 150 in at least one transverse direction with respect to the longitudinal direction of motion of the pneumatic tube transport device 100 through the pneumatic tube system. As may be understood from FIG. 2, the pneumatic tube transport device 100 is substantially structurally similar to the pneumatic tube transport device 100 shown and described with respect to FIG. 1. In the embodiment shown in FIG. 2, the longitudinal direction support 110 is slidably coupled to each of the first transverse direction support 120A and the first transverse direction support 120B via a respective sliding connector 124 (e.g., a first sliding connector 124A and a second sliding connector 124A). In various embodiments, the pneumatic tube transport device 100 further comprises a second actuator 122 in mechanical communication with the longitudinal direction support 110 such that the second actuator 122 is configured to cause the longitudinal direction support 110 to translate in a transverse direction (e.g., the Y-direction) within the pneumatic tube transport device 100 with respect to the longitudinal direction of motion of the pneumatic tube transport device 100 through the pneumatic tube system. As may be understood from FIG. 2, the transverse direction (Y-direction) is substantially perpendicular to the longitudinal direction of travel (e.g., the Z-direction). In the embodiment shown in FIG. 2, the control circuitry 109 is configured to operate each of the first actuator 112 and the second actuator 122 to apply motion to the sample housing 150 in a direction that corresponds to the respective longitudinal (e.g., substantially co-linear with the longitudinal direction support 110) and/or transverse (e.g., substantially co-linear with the first transverse direction support 120) direction. In some aspects, the control circuitry 109 is configured to operate each of the first actuator 112 and the second actuator 122 in a direction opposite a motion detected via the gyroscope 107 (e.g., or other suitable sensor) in two directions (e.g., the Z-direction and the Y-direction).

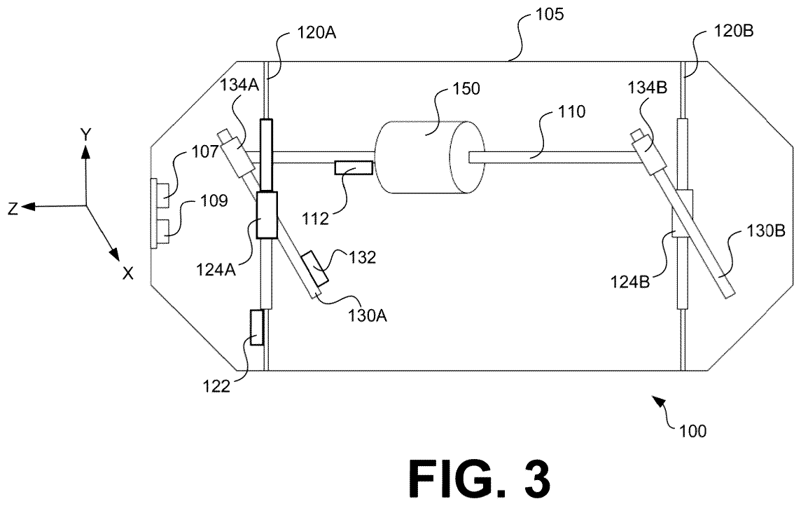

Turning to FIG. 3, yet another embodiment of a pneumatic tube transport device 100 is shown. In the embodiment shown in this FIG., the pneumatic tube transport device 100 is substantially structurally similar to the pneumatic tube transport device 100 shown in FIG. 2. In the embodiment shown in FIG. 3, the pneumatic tube transport device 100 further comprises a second transverse direction support 130A that is substantially perpendicular to the first transverse direction support 120A and coupled to the first transverse direction support 120A via a sliding connector 124A. Additionally, the pneumatic tube transport device 100 comprises a second transverse direction support 130B that is substantially parallel to and spaced apart from the second transverse direction support 130A. The second transverse direction support 130B is perpendicular to the first transverse direction support 120B and coupled to the first transverse direction support 120B via a sliding connector 124B. In the embodiment shown in this figure, a first end of the longitudinal direction support 110 is slidably coupled to the second transverse direction support 130A via a sliding connector 134A. A second end of the longitudinal direction support 110 is slidably coupled to the second transverse direction support 130B via a sliding connector 134B. The pneumatic tube transport device 100 further comprises a third actuator 132 in mechanical communication with the longitudinal direction support 110 such that the third actuator 132 is configured to cause the longitudinal direction support 110 to translate in a second transverse direction (e.g., the X-direction) within the pneumatic tube transport device 100 with respect to the longitudinal direction of motion of the pneumatic tube transport device 100 through the pneumatic tube system. As may be understood from FIG. 3, the second transverse direction (e.g., X-direction) is substantially perpendicular to the longitudinal direction of travel (e.g., the Z-direction). In some embodiments, the second transverse direction (e.g., X-direction) is substantially perpendicular to a first transverse direction (e.g., the Y-direction, the transverse direction described above with respect to FIG. 2).

In the embodiment shown in FIG. 3, the control circuitry 109 is configured to operate each of the first actuator 112, the second actuator 122, and the third actuator 132 to apply motion to the sample housing 150 in a direction that corresponds to the respective longitudinal (e.g., substantially co-linear with the longitudinal direction support 110) and/or transverse (e.g., substantially co-linear with the first transverse direction support 120 and/or the second transverse direction support 130) direction. In some aspects, the control circuitry 109 is configured to operate each of the first actuator 112, the second actuator 122, and the third actuator 132 in a direction opposite a motion detected via the gyroscope 107 (e.g., or other suitable sensor) in three directions (e.g., the X-direction, the Y-direction, and the Z-direction).

In any embodiment described herein, any of the longitudinal direction support 110, the first transverse direction support 120 and/or the second transverse direction support 130 may comprise one or more dampeners (e.g., one or more dashpots, one or more biasing mechanism, etc.). In some aspects, each of the one or more dampeners are configured to reduce an amount of force experienced by the sample housing 150 during an application of force on the sample housing 150 resulting from travel through a pneumatic tube system. In some aspects, the one or more dampeners comprise one or more linear dampeners. In some aspects, the one or more dampeners are disposed parallel to the longitudinal direction support 110, the first transverse direction support 120, or the second transverse direction support 130 in which the one or more dampeners are comprised.

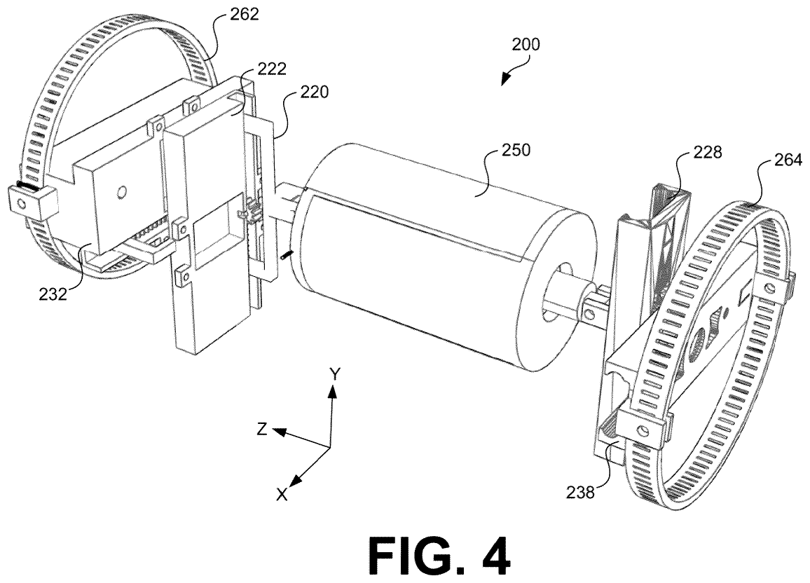

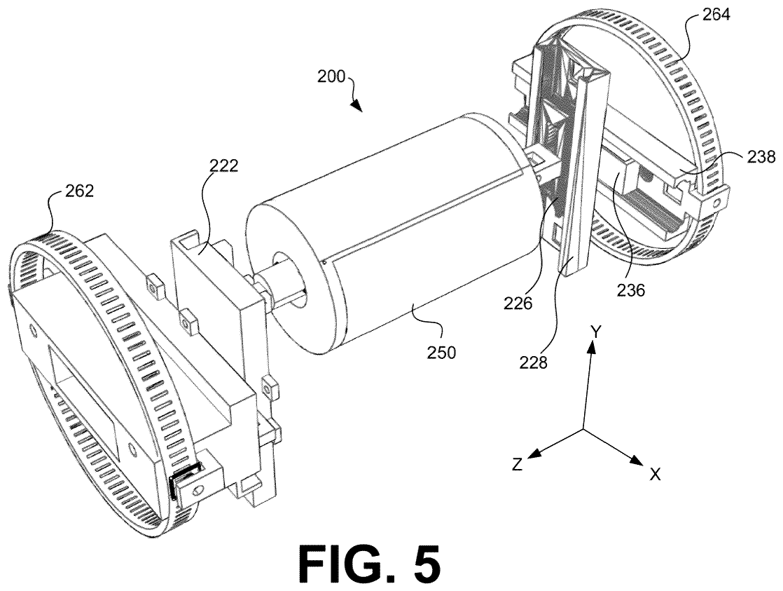

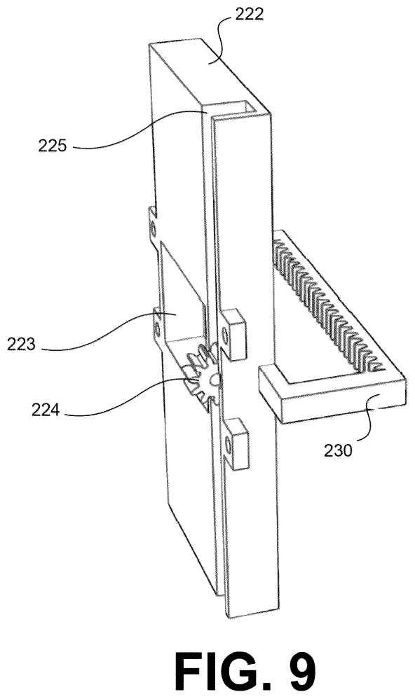

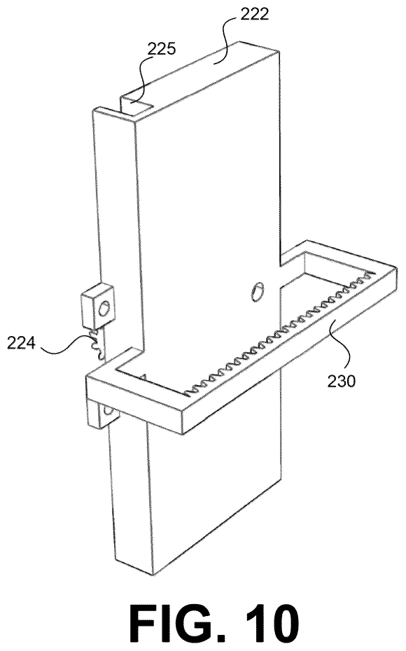

FIGS. 4-17 depict a pneumatic tube insert 200 and various components of a pneumatic tube insert 200 according to yet another embodiment of the present disclosure. In the embodiment shown in FIGS. 4 and 5, the pneumatic tube insert 200 is configured for at least temporary insertion into a pneumatic tube carrier. As with the sample housing 150 described above with respect to the pneumatic tube transport device 100, the pneumatic tube insert 200 comprises a sample housing 250. In various embodiments, the sample housing 250 is configured to receive and at least temporarily store one or more samples, for example, while the pneumatic tube insert 200 is travelling through a pneumatic tube system (e.g., in a pneumatic tube carrier). In some aspects, the one or more samples may include one or more test tubes, vials, or other storage mediums.

A first end of the sample housing 250 is coupled to (e.g., rotatably coupled to) a first transverse direction rack 220. As may be understood in light of this disclosure and FIG. 4, the first transverse direction rack 220 is configured to translate in a transverse direction (e.g., the Y-direction) with respect to a longitudinal direction of travel (e.g., the Z-direction) of the pneumatic tube insert 200 when the pneumatic tube insert 200 is travelling through a pneumatic tube system). The first transverse direction rack 220 is slidably coupled to an actuator support 222 that supports an actuator (not pictured) configured to linearly translate the first transverse direction rack 220 in a first transverse direction (e.g., the Y-direction). In some embodiments, the linear translation of the first transverse direction rack 220 causes linear translation of at least the first end of the sample housing 250 (e.g., the sample housing 250).

The actuator support 222 is slidably coupled to a second actuator support 232 that supports an actuator (not pictured) configured to linearly translate the actuator support 222 in a second transverse direction (e.g., the X-direction) that is perpendicular to the first transverse direction. In some aspects, the actuator support 232 is at least temporarily coupled to a first hose clamp 262 that is configured to expand within a pneumatic tube carrier in order to engage an inner portion of the pneumatic tube carrier and maintain the pneumatic tube insert 200 in a substantially fixed position within the pneumatic tube carrier. In some aspects, the use of at least one hose clamp to support the pneumatic tube insert 200 within a pneumatic tube may enable a user to quicky and easily insert and remove the insert from the pneumatic tube. Additionally, the use of one or more hose clamps may enable the insert to fit stably within pneumatic tubes of differing sizes. This may, for example, enable a user to utilize the pneumatic tube insert 200 with different pneumatic tube systems at different locations that have different configurations (e.g., size, diameter, etc.). In other embodiments, the pneumatic tube insert 200 may comprise any other mechanism for at least temporarily engaging with an inner portion of the pneumatic tube carrier in order to maintain the pneumatic tube insert 200 in a substantially fixed position within the pneumatic tube carrier (e.g., during transportation in a pneumatic tube system).

As shown in FIG. 5, a second end of the sample housing 250 is coupled to (e.g., rotatably coupled to) a first transverse direction slider 226. As may be understood in light of this disclosure and FIG. 5, the first transverse direction slider 226 slidably disposed within a first transverse direction slider support track 228 and is configured to translate within the first transverse direction slider support track 228 in a transverse direction (e.g., the Y-direction) with respect to a longitudinal direction of travel (e.g., the Z-direction) of the pneumatic tube insert 200 when the pneumatic tube insert 200 is travelling through a pneumatic tube system). The first transverse direction slider support track 228 comprises a second transverse direction slider 236 that is substantially perpendicular to a body of the first transverse direction slider support track 228 and slidably disposed within a second transverse direction slider support track 238. As may be understood from FIGS. 4 and 5, the second transverse direction slider 236 is configured to translate within the second transverse direction slider support track 238 in a second transverse direction (e.g., the X-direction) with respect to a longitudinal direction of travel (e.g., the Z-direction) of the pneumatic tube insert 200 when the pneumatic tube insert 200 is travelling through a pneumatic tube system).

In some aspects, the first transverse direction slider 226 is configured to slide within the first transverse direction slider support track 228 in response to an actuation of the first transverse direction rack 220 (i.e., the first transverse direction slider 226 is configured to substantially freely slide and/or translate within the first transverse direction slider support track 228). Similarly, the second transverse direction slider 236 may be configured to slide within the second transverse direction slider support track 238 in response to an actuation of the actuator support 222 (e.g., by an actuator supported by the actuator support 232). In this way, the sample housing 250 may be configured to translate in both a first transverse direction (e.g., the Y-direction) and a second transverse direction (e.g., the X-direction) such that the sample housing 250 remains substantially parallel to the longitudinal direction of travel of the pneumatic tube insert 200 when the pneumatic tube insert 200 is travelling through a pneumatic tube system. For example, the pneumatic tube insert 200 may comprise one or more actuators configured to actuate the first end of the sample housing 250, and the second end of the sample housing 250 may translate along with the first end as a result of a sliding and/or translation of the first transverse direction slider 226 and the second transverse direction slider 236.

In some aspects, the second transverse direction slider support track 238 is at least temporarily coupled to a second hose clamp 264 that is configured to expand within a pneumatic tube carrier in order to engage an inner portion of the pneumatic tube carrier and maintain the pneumatic tube insert 200 in a substantially fixed position within the pneumatic tube carrier. In other embodiments, the pneumatic tube insert 200 may comprise any other mechanism (e.g., and/or mechanisms) for at least temporarily engaging with an inner portion of the pneumatic tube carrier in order to maintain the pneumatic tube insert 200 in a substantially fixed position within the pneumatic tube carrier (e.g., during transportation in a pneumatic tube system)

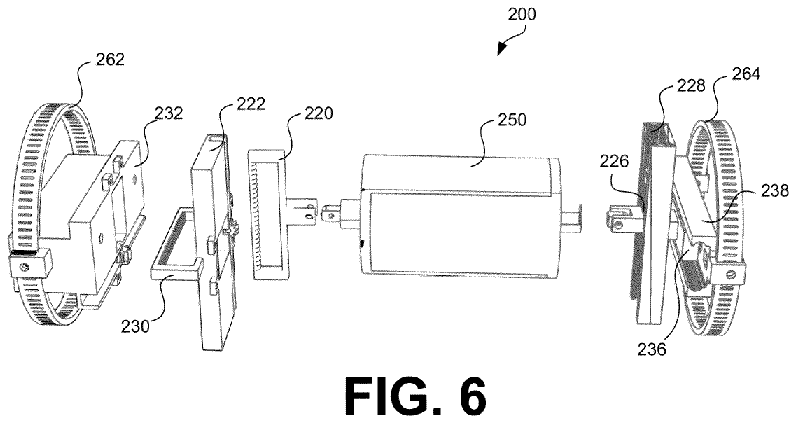

FIG. 6 depicts an exploded view of the pneumatic tube insert 200 shown in FIGS. 4 and 5. As may be understood from this figure, the actuator support 222 comprises a second transverse direction rack 230 that is substantially perpendicular to the first transverse direction rack 220. In various embodiments, the second transverse direction rack 230 is configured to interact with a corresponding pinion (e.g., gear) operated by a suitable actuator (not pictured) in order to impart a linear translation on the second transverse direction rack 230 with respect to the actuator support 232.

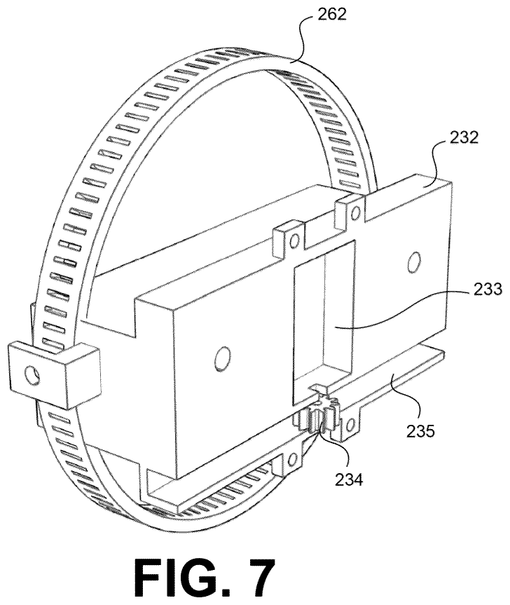

FIG. 7 depicts a detail view of a first end of the pneumatic tube insert 200. As may be understood from this figure, the actuator support 232 defines an actuator support 233 configured to receive an actuator (e.g., motor). The actuator support 232 further defines a track 235 that is substantially parallel to a transverse axis of the pneumatic tube insert 200 when the pneumatic tube insert 200 is travelling through a pneumatic tube system. As may be understood from FIG. 7 and FIG. 6, the track 235 is sized and configured to receive at least a portion of the second transverse direction rack 230 such that opposing portions of the actuator support 232 maintain the second transverse direction rack 230 within the track 235. The actuator support 232 further comprises a rotating connector 234 disposed at least partially within the track 235. As may be understood in light of these figures, the rotating connector 234 is configured to maintain the second transverse direction rack 230 within the track 235 and further configured to rotate in response to actuation by an actuator (not pictured). In some embodiments, the rotating connector 234 cooperates with the track 235 to maintain at least a portion of the second transverse direction rack 230 within the track 235. In this way, the second transverse direction rack 230 is configured to translate within the track 235 in response to a rotation of the rotating connector 234.

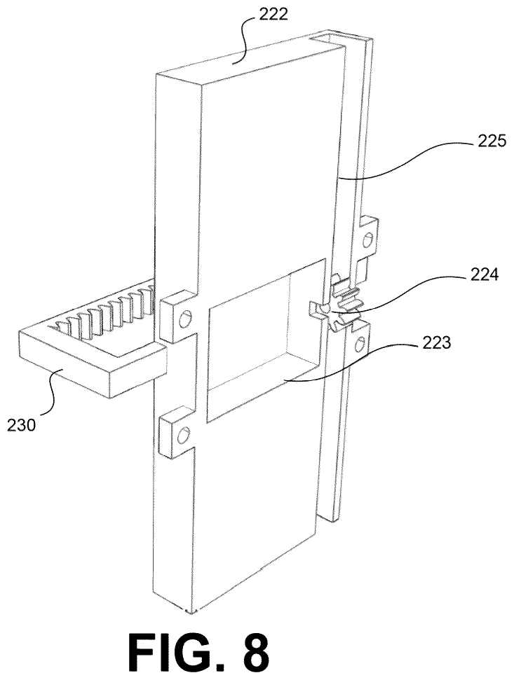

FIGS. 8-10 depict detail views of the actuator support 222. As may be understood from these figures, the actuator support 222 comprises a substantially rectangular body defining an actuator receiving recess 223 configured to receive an actuator (e.g., motor). The actuator support 222 further defines a track 225 that is substantially parallel to a transverse axis of the pneumatic tube insert 200 when the pneumatic tube insert 200 is travelling through a pneumatic tube system. As may be understood these figures, the track 225 is sized and configured to receive at least a portion of the actuator support 232 such that opposing portions of the actuator support 222 maintain the first transverse direction rack 220 within the track 225. The actuator support 222 further comprises a rotating connector 224 disposed at least partially within the track 225. As may be understood in light of these figures, the rotating connector 224 is configured to maintain the first transverse direction rack 220 within the track 225 and further configured to rotate in response to actuation by an actuator (not pictured). In this way, the first transverse direction rack 220 is configured to translate within the track 225 in response to a rotation of the rotating connector 224.

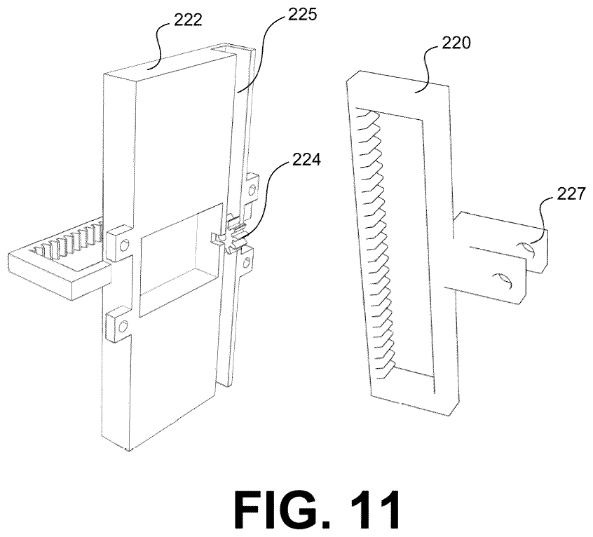

The actuator support 222 further comprises a second transverse direction rack 230 that extends from a rear portion of the actuator support 222. The second transverse direction rack 230 is substantially perpendicular to the body of the actuator support 222. FIG. 11 depicts the actuator support 222 with the first transverse direction rack 220. As may be understood from this figure, the first transverse direction rack 220 is configured to slidably nest within the track 225, maintained within the track 225 by at least the rotating connector 224. The first transverse direction rack 220 further comprises a sample housing connector 227 configured to at least temporarily couple the first transverse direction rack 220 to the sample housing 250.

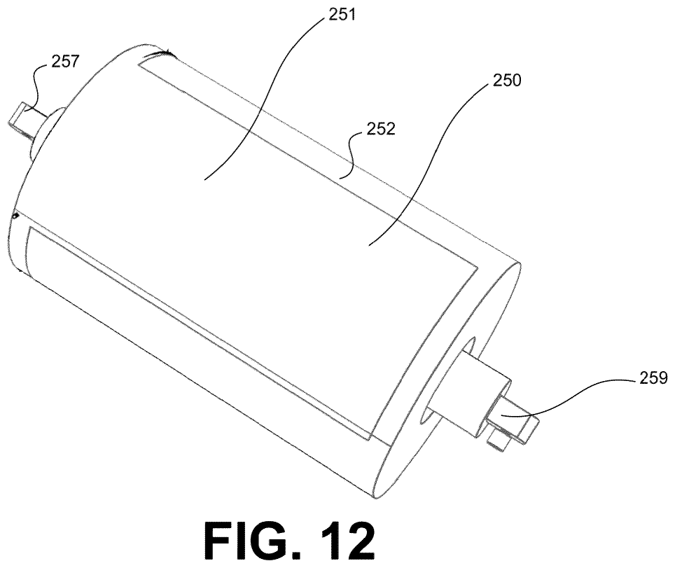

FIG. 12 depicts a detail view of the sample housing 250. As shown in this figure, the sample housing 250 comprises a first connector 257 disposed adjacent the first end of the sample housing 250. The first connector 257 may be configured to at least temporarily couple (e.g., ratably couple via a suitable pin or other rotating member) to the sample housing connector 227 of the first transverse direction rack 220 (shown in FIG. 11). The sample housing 250 further comprise a second connector 259 adjacent the second end of the sample housing 250. The second connector 259 may be configured to couple to at least temporarily couple (e.g., ratably couple via a suitable pin or other rotating member) to a sample housing connector 227 (described more fully below) of the first transverse direction slider 226. The sample housing 250 further comprise a first housing portion 251 and a second housing portion 252. The first housing portion 251 and the second housing portion 252 form a substantially cylindrical housing configured to at least temporarily store one or more samples, such as those described herein.

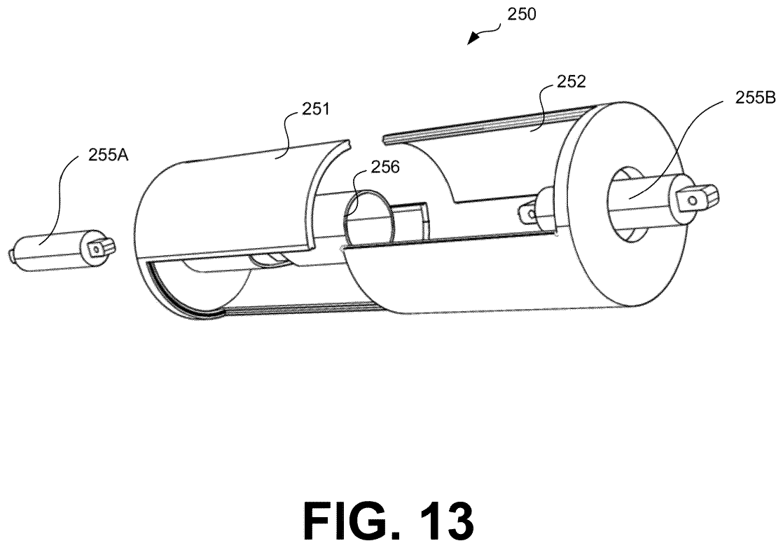

FIG. 13 depicts an exploded view of the sample housing 250. The first housing portion 251 may include a suitable casing to receive one or more sample housings such as a test tube. In some embodiments the second housing portion 252 provides a lid of the casing of first housing portion 251 to at least temporarily store one or more samples within the sample housing 250 during transportation.

As may be understood from this figure, the sample housing 250 further comprises a substantially cylindrical dampener housing portion 256 that is configured to receive at least one linear dampener and/or longitudinal support for the sample housing 250. In the embodiment shown in this figure, the sample housing 250 comprises a first linear dampener 255A and a second linear dampener 255B. In any embodiment described herein, the first linear dampener 255A and the second linear dampener 255B may comprise one or more dampeners (e.g., one or more dashpots, one or more biasing mechanism, etc.) configured to reduce an amount of force experienced by the sample housing 250 during transportation. In some embodiments, the linear dampener 255A and the linear dampener 255B form part of a longitudinal direction support 110 (e.g., described above with respect to FIGS. 1-3). In various embodiments, the pneumatic tube insert 200 further comprise at least one actuator (not pictured) configure to cause translation of the sample housing 250 along the longitudinal direction support 110.

In still other embodiments, a first linear dampener 255A and a second linear dampener 255B (e.g., one or more linear dampeners) may be disposed adjacent to the sample housing 250 rather than at least partially within the sample housing 250. In such embodiments, one or more linear dampeners may provide a dampening buffer along any suitable axis described herein. In some embodiments, for example, each linear dampener may have a first end and a second end. In such embodiments, a first end of each linear dampener may be coupled to any suitable portion of the sample housing 250. The second end of each linear dampener may then be coupled any suitable portion of the pneumatic tube insert 200 (e.g., or the pneumatic tube itself). In particular embodiments, each linear dampener is coupled to any suitable portion of the sample housing 250 and/or pneumatic tube insert 200 but is not coupled directly to a second linear dampener.

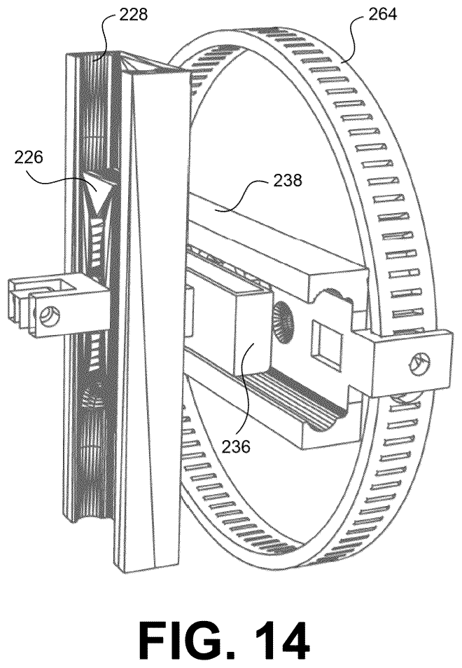

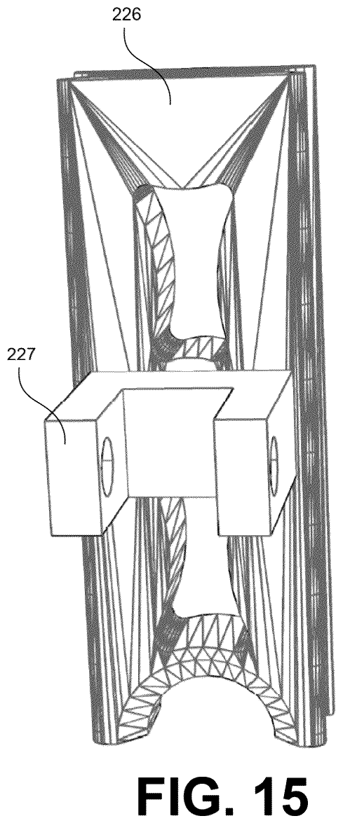

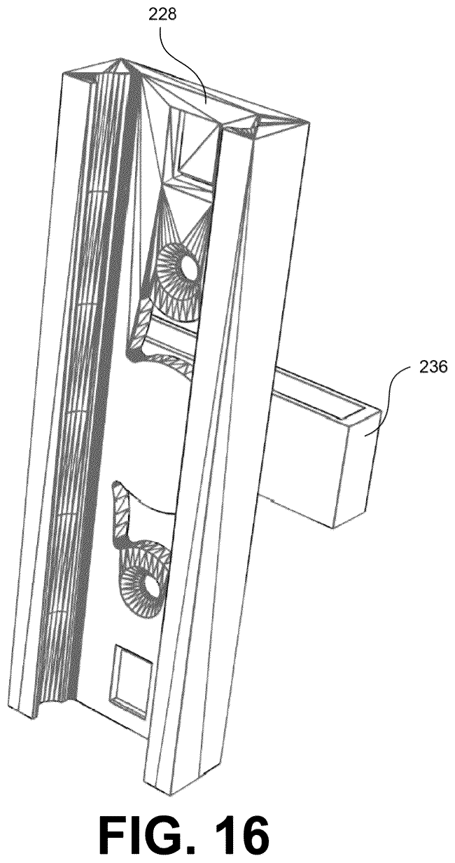

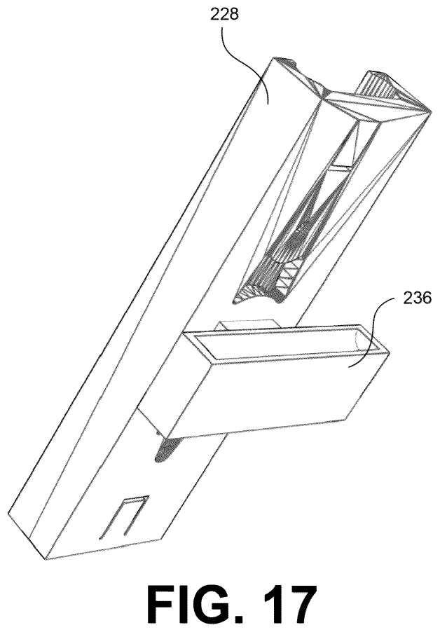

FIG. 14 depicts a detail view of a second end of the pneumatic tube insert 200. As shown in this figure, the first transverse direction slider 226 is slidably disposed within the first transverse direction slider support track 228 and configured to slide and/or translate linearly within a track defined by the first transverse direction slider support track 228. Similarly, the second transverse direction slider 236 is slidably disposed in the second transverse direction slider support track 238 and configured to slide and/or translate within a track defined by the second transverse direction slider support track 238. FIG. 15 depicts a detail view of the first transverse direction slider 226. As shown in this figure, the first transverse direction slider 226 comprises a sample housing connector 227 extending from a front face of the first transverse direction slider 226 and configured to couple to the second connector 259. FIGS. 16 and 17 depict detail views of the first transverse direction slider support track 228. As shown in these figures, the first transverse direction slider support track 228 defines a track configured to receive the first transverse direction slider 226. The first transverse direction slider support track 228 comprises a substantially rectangular body and a second transverse direction slider 236 extending from a rear portion of the first transverse direction slider support track 228. The second transverse direction slider 236 is substantially parallel to the first transverse direction slider support track 228 and configured to translate within a track defined by the second transverse direction slider support track 238.

### Pneumatic Tube Transport Device Component Control Process

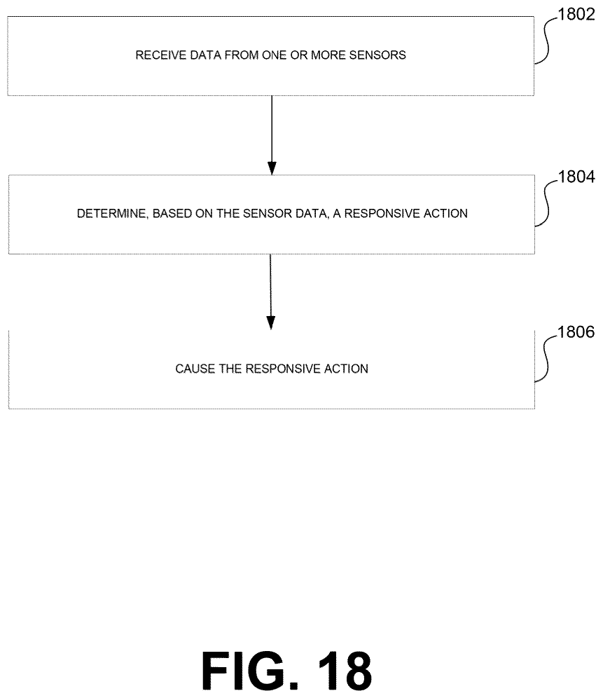

FIG. 18 depicts an exemplary process for controlling pneumatic tube transport device components based on sensor data in accordance with various embodiments of the present disclosure. This process may, for example, include operations that computing hardware in the pneumatic tube insert 200 (e.g., the control circuitry 109) may execute to activate one or more actuators in response to sensor readings received by the computing hardware. In any embodiment described herein, the computing hardware and/or control circuitry 109 may comprise any suitable processing circuitry configured to receive and interpret sensor data from a gyroscope or other sensor, determine opposing force and/or motion data to at least partially counteract a motion and/or force on the sample housing, and cause one or more actuators at least temporarily impart an at least partially counteracting motion and/or force on the sample housing. The computing hardware may, for example, comprise any suitable microcontroller.

For instance, the flow diagram shown in FIG. 18 may correspond to operations performed by computing hardware found in the pneumatic tube insert 200 that is operatively coupled to both one or more sensors and one or more actuators in the pneumatic tube insert 200.

At operation 1802, the computing hardware (e.g., control circuitry 109) receives data from one or more sensors disposed in and/or on the pneumatic tube insert 200. The computing hardware may receive the data while the pneumatic tube insert 200 is travelling through a pneumatic tube system. In some embodiments, the data received from the one or more sensors may include, for example: (1) velocity data (e.g., direction and speed); (2) acceleration data; (3) temperature data; (4) force data; (5) identification data (e.g., from an RFID tag or other unique identifier); (6) etc.

At operation 1084, the computing hardware determines, based on the sensor data, a responsive action. In some embodiments, the responsive action is configured to counteract, reduce, or otherwise negate a force, moment, acceleration, change in position, velocity, or other outside force experienced by a sample disposed within the sample housing 250 during transportation. For example, in some embodiments, the computing hardware may determine a responsive action that includes applying an opposing force, velocity, acceleration, etc. to a force, velocity, or acceleration identified from the sensor data. By determining to move the sample housing 250 in a direction opposing a detected direction of movement, the system may reduce an amount of force on a sample housed within the sample housing 250, and reduce a likelihood that the sample will be damaged or unsuitable for use.

In still other embodiments, the responsive action may include generating an alert and transmitting the alert to a suitable computing device or otherwise making the alert accessible via a suitable computing device. The responsive action may, for example, include generating and/or modifying a user interface to include the alert. The alert may include, for example, an alert that the pneumatic tube insert 200 has experienced a temperature outside of a desired range, that a sample in the sample housing 250 has experienced a force or rate of travel so great, that the sample is likely unusable despite the use of other potential responsive actions (such as applying counteracting motion to the sample), etc. In some aspects, the pneumatic tube insert 200 may include a suitable indicator (e.g., a light, display screen, etc.) that the computing hardware may activate to provide an indication of an alert.

In some embodiments, the computing hardware is configured to substantially continuously determine responsive actions as the computing hardware continues to receive sensor data.

At operations 1806, the computing hardware may cause the responsive action. In some embodiments, the responsive action may include any suitable responsive action described herein (e.g., applying an opposing movement in any of three dimensions, etc.). Causing the responsive action may, for example, comprise causing operation of any of the set of actuators that make up the pneumatic tube insert 200.

Following the responsive action, the computing hardware may optionally revert the pneumatic tube insert 200 to an initial configuration. The initial configuration may include, for example, a default position of the sample housing 250 within the pneumatic tube insert 200. So, for example, in embodiments in which the computing hardware applies an anti-parallel linear motion to the sample housing 250 (e.g., in the longitudinal direction or one or more transverse directions), the one or more actuators may be configured to, following a particular distance of travel of the sample housing 250, bias or otherwise translate the sample housing 250 back to a default position (e.g., substantially centrally disposed within the pneumatic tube insert 200 and/or pneumatic tube carrier). For example, the one or more actuators may cooperate to actuate the sample housing 250 back to the default position by translating the sample housing 250 at least partially in a direction and for at least partially a distance opposite the direction and distance by which the one or more actuators translated the sample housing 250 as part of the responsive action.

### Pneumatic Tube Transport Device Tracking and Initialization Processes

In some embodiments a pneumatic tube transport device may include one or more unique identifiers such as an RFID tag, machine-readable indicia (e.g., QR code, barcode, etc.). In some aspects, a pneumatic tube transport system may include one or more unique identifier readers disposed at various locations throughout the system. In this way, the system may be configured to track a location of a particular sample (e.g., through tracking a location of a pneumatic tube in which the sample is disposed) by identifying the unique identifier from a particular pneumatic tube at a particular location in the system. In some aspects, the system may, for example, be configured to track a start and end location, time of transport, and/or other location data for a particular sample. In any embodiment described herein, the system may generate a user interface for display on a suitable computing device that includes an indication of the location information for a particular sample.

For example, in the context of the Pneumatic Tube Transport Device Component Control Process discussed above, the process may involve receiving location data for the sample based on scanning an RFID tag or suitable machine-readable indicia on the pneumatic tube and/or pneumatic tube insert in which the sample is housed. For example, when a user is utilizing a pneumatic tube system to transport a patient sample, the user may perform an initial RFID scan of the pneumatic tube carrier (e.g., or insert). The user may then access a user interface to provide data related to the sample. This may include, for example, a patient identifier, a sample identifier, a sample destination, etc. The system may then scan the RFID tag as the tube carrier passes particular RFID scanners along the pneumatic tube system in order to update a substantially current location of the sample within the system. The process may then generate and/or update a user interface to include information related to the location data (e.g., start/end location, path of transit through the pneumatic tube system, transportation time, etc.).

Additionally, the system or process described herein may utilize sample data to determine a maximum threshold of g-forces and other environmental limits for a particular sample. The system may then track environmental factors such as temperature, forces, etc. experienced by the same (e.g., using one or more sensors described herein) to determine whether the sample has experienced environmental conditions that are outside of an acceptable range. In response to determining that a sample has experienced such conditions, the system may generate and/or modify a user interface to include an indication of such experience in association with the sample. The system may then provide the user interface for display on a user computing device.

It should be emphasized that the above-described examples of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A sample transportation system comprising:
a housing;
at least one gyroscope sensor disposed within the housing;
a substantially linear track disposed within the housing, the substantially linear track being substantially parallel to a longitudinal direction of travel of the housing within the sample transportation system;
a sample receptacle slidably coupled to the substantially linear track;
at least one motor in mechanical communication with at least one of the sample receptacle or the substantially linear track, the at least one motor configured to cause the sample receptacle to translate parallel to the substantially linear track with respect to the housing; and
computing hardware disposed within the housing and coupled to the at least one gyroscope sensor, wherein the computing hardware is configured to:
receive velocity data from the at least one gyroscope sensor; and
operate the at least one motor to cause the sample receptacle to translate with respect to the housing based on the velocity data.

2. The sample transportation system of claim 1, wherein operating the at least one motor to cause the sample receptacle to translate with respect to the housing based on the velocity data comprises operating the at least one motor to translate the sample receptacle antiparallel to a direction of travel identified based on the velocity data.

3. The sample transportation system of claim 1, further comprising:
a second substantially linear track disposed within the housing, the second substantially linear track being oriented in a first transverse direction that is substantially perpendicular to the longitudinal direction of travel of the housing within the sample transportation system;
a second motor in mechanical communication with at least one of the sample receptacle or the second substantially linear track, the second motor configured to cause the sample receptacle to translate parallel to the first transverse direction, wherein:
a first end of the substantially linear track is slidably coupled to the second substantially linear track; and
the computing hardware is further configured to operate the second motor to cause the sample receptacle to translate in the transverse direction with respect to the housing based on the velocity data.

4. The sample transportation system of claim 1, further comprising:
a third substantially linear track disposed within the housing, the third substantially linear track being oriented in a second transverse direction that is substantially perpendicular to both the longitudinal direction and the second longitudinal direction;
a third motor in mechanical communication with at least one of the sample receptacle or the third substantially linear track, the third motor configured to cause the sample receptacle to translate parallel to the second transverse direction, wherein:
the computing hardware is further configured to operate the third motor to cause the sample receptacle to translate in the second transverse direction with respect to the housing based on the velocity data.

5. The sample transportation system of claim 1, wherein the sample transportation system is configured for at least one of insertion into a pneumatic tube carrier for use in the sample transportation system or standalone use in the sample transportation system.

6. The sample transportation system of claim 1, wherein the substantially linear track comprises at least one integrated dampener.

7. The sample transportation system of claim 1, wherein operating the at least one motor to cause the sample receptacle to translate with respect to the housing based on the velocity data comprises causing the sample receptacle to translate in the longitudinal direction at a velocity opposite a velocity determined from the velocity data.

8. A pneumatic tube carrier comprising:
a longitudinal direction support that is substantially parallel to a longitudinal direction of travel of the pneumatic tube carrier when the pneumatic tube carrier is travelling through a pneumatic tube system;
a sample housing disposed on the longitudinal direction support;
at least one actuator operatively coupled to the sample housing and configured to cause the sample housing to translate substantially parallel along at least a portion of the longitudinal direction support;
at least one sensor disposed on or in the pneumatic tube carrier; and
computing hardware operatively coupled to the at least one sensor and the at least one actuator, wherein the computing hardware is configured for:
receiving sensor data from the at least one sensor;
determining a set of actuator instructions based on the sensor data; and
operating the at least one actuator according to the set of actuator instructions to at least partially counteract a force, velocity, direction of motion, or acceleration identified based on the sensor data.

9. The pneumatic tube carrier of claim 8, wherein the longitudinal direction support comprises at least one integrated dampener.

10. The pneumatic tube carrier of claim 9, wherein the at least one integrated dampener comprise at least one biasing mechanism or at least one dashpot.

11. The pneumatic tube carrier of claim 8, wherein:
the sensor data comprises a force on the pneumatic tube carrier;
the responsive action comprises causing the at least one actuator to apply a force that is opposing of the force on the pneumatic tube carrier on the sample housing.

12. The pneumatic tube carrier of claim 8, wherein:
the at least one actuator comprises a set of actuators; and
the set of actuators are configured to cooperate to at least partially counteract the force, velocity, direction of motion, or acceleration identified by translating the sample housing in three dimensions.

13. The pneumatic tube carrier of claim 8, further comprising:
a first transverse direction support substantially perpendicular to the longitudinal direction support, wherein the at least one actuator is further configured to cause the sample housing to translate substantially parallel along at least a portion of the first transverse direction support.

14. The pneumatic tube carrier of claim 13, further comprising:
a second transverse direction support substantially perpendicular to the longitudinal direction support and the first transverse direction support, wherein the at least one actuator is further configured to cause the sample housing to translate substantially parallel along at least a portion of the second transverse direction support.

15. A pneumatic tube insert comprising;
a sample housing;
at least one actuator operatively coupled to the sample housing and configured to cause the sample housing to translate in a direction substantially parallel to a longitudinal direction of travel of the pneumatic tube insert when the pneumatic tube insert is travelling through a pneumatic tube system;
at least one sensor disposed on or in the pneumatic tube insert; and
computing hardware operatively coupled to the at least one sensor and the at least one actuator, wherein the computing hardware is configured for:
receiving sensor data from the at least one sensor;
determining a responsive action based on the sensor data; and
causing the responsive action.

16. The pneumatic tube insert of claim 15, wherein:
the sensor data comprises a velocity of the pneumatic tube insert;
the responsive action comprises causing the sample housing to translate in the longitudinal direction in a direction opposite the velocity of the pneumatic tube insert at a rate that corresponds to the velocity; and
causing the responsive action comprises causing the at least one actuator to translate the sample housing in the longitudinal direction in the direction opposite the velocity of the pneumatic tube insert at the rate that corresponds to the velocity.

17. The pneumatic tube insert of claim 15, wherein the pneumatic tube insert is configured to be selectively inserted into a pneumatic tube carrier for use in the pneumatic tube system.

18. The pneumatic tube insert of claim 15, wherein:
the at least one sensor comprises at least one of a gyroscope, an accelerometer, or a temperature sensor;
the responsive action comprises at least one of activating the at least one actuator, generating a temperature alert; or generating an excessive force alert.

19. The pneumatic tube insert of claim 15, wherein:
the pneumatic tube insert comprises:
a first transverse direction rack;
an actuator support defining a linear track, wherein the actuator support is configured to receive the at least one actuator and the linear track is configured to receive at least a portion of the first transverse direction rack such that the first transverse direction rack is slidably disposed within the linear track;
a rotating connector coupled to the at least one actuator, the rotating connector in operable engagement with the first transverse direction rack;
a first end of the sample housing is coupled to the first transverse direction rack; and
the responsive action comprises operating the at least one actuator to rotate the rotating connector to cause the first transverse direction rack to translate at least the first end of the sample housing in a transverse direction relative to the longitudinal direction of travel of the pneumatic tube insert when the pneumatic tube insert is travelling through the pneumatic tube system.

20. The pneumatic tube insert of claim 19, wherein:
the actuator support comprises a second transverse direction rack substantially perpendicular to the transverse direction rack;
the pneumatic tube insert comprises a second actuator support defining a second linear track, wherein the second actuator support is configured to receive a second actuator, and the second linear track is configured to receive at least a portion of the second transverse direction rack such that the second transverse direction rack is slidably disposed within the second linear track;
a second rotating connector coupled to the second actuator, the second rotating connector in operable engagement with the second transverse direction rack;
the responsive action comprises operating the second actuator to rotate the second rotating connector to cause the second transverse direction rack to translate at least the actuator support in the second transverse direction relative to the longitudinal direction of travel of the pneumatic tube insert when the pneumatic tube insert is travelling through the pneumatic tube system; and
the transverse direction is substantially perpendicular to the second transverse direction.
